(19) United States
(12) Patent Application Publication
(10) Pub. No.: US 2022/0155941 A1
(43) Pub. Date: May 19, 2022

(54) APPARATUSES AND METHODS TO FACILITATE A PRESENTATION OF CONTENT ITEMS VIA A PROXY REPRESENTATIVE OF MULTIPLE SOURCES

(71) Applicant: AT&T Intellectual Property I, L.P., Atlanta, GA (US)

(72) Inventor: Binny Asarikuniyil, Cerritos, CA (US)

(73) Assignee: AT&T Intellectual Property I, L.P., Atlanta, GA (US)

(21) Appl. No.: 16/952,578

(22) Filed: Nov. 19, 2020

(51) Int. Cl. G06F 3/0484; H04L 29/08

(52) U.S. Cl. CPC G06F 3/04842; H04L 67/18

(57) ABSTRACT

Aspects of the subject disclosure may include, for example, obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. Other embodiments are disclosed.

### FIELD OF THE DISCLOSURE

The subject disclosure relates to apparatuses and methods to facilitate a presentation of content items via a proxy representative of multiple sources.

### BACKGROUND

As the world becomes increasingly connected through vast communication networks and via various communication devices, additional opportunities are generated to provision content to users. More generally, users (or, analogously, communication devices associated with users) may potentially obtain a content item, such as a video, from multiple sources. Still further, in some instances a communication device may obtain portions of a content item from various other communication devices and then “stitch” the portions together to facilitate a playback/rendering/presentation of the content item by the communication device.

The availability of multiple sources/outlets that may potentially provide one or more portions of a content item presents challenges to the playback of the content item. For example, if a user decides to change the source of a first content item from a first source to a second source, there may be a delay from the point in time when the user selects the change until the playback of the first content item can proceed via the second source. Similarly, if the user decides to change the content item that is being presented from the first content item to a second content item, there may be a similar delay. In some instances, a user might not be aware of content items that are available, as the user might be unaware of the existence of a given content item or a given source. In this regard, a user may suffer a degraded quality of experience (QoE) from the lack of awareness.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for aggregating content items available from multiple sources within a common framework. Other embodiments are described in the subject disclosure.

One or more aspects of the subject disclosure include, in whole or in part, obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored.

One or more aspects of the subject disclosure include, in whole or in part, obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest.

One or more aspects of the subject disclosure include, in whole or in part, determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider to cause the communication device to present the first content item and the second content item.

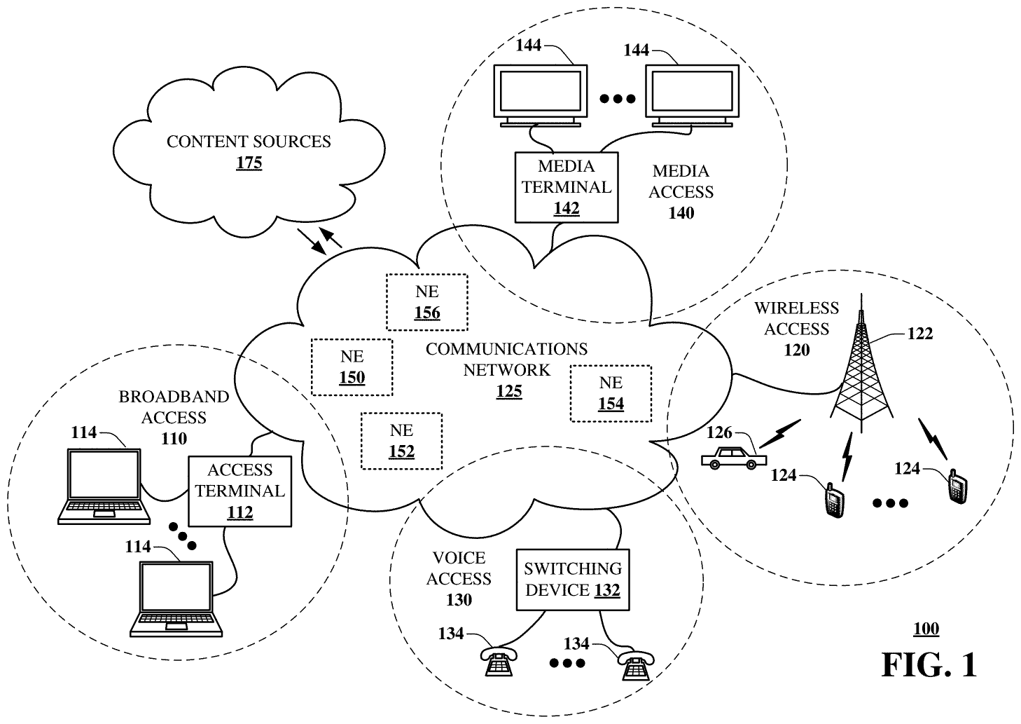

Referring now to FIG. 1, a block diagram is shown illustrating an example, non-limiting embodiment of a system 100 in accordance with various aspects described herein. For example, system 100 can facilitate, in whole or in part, obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored. System 100 can facilitate, in whole or in part, obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. System 100 can facilitate, in whole or in part, determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

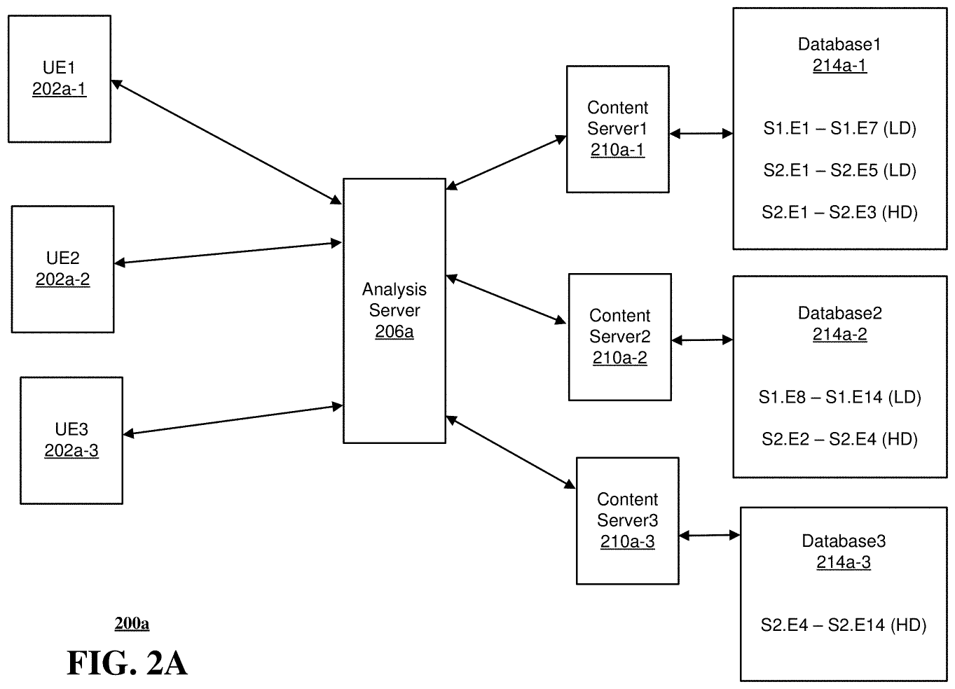

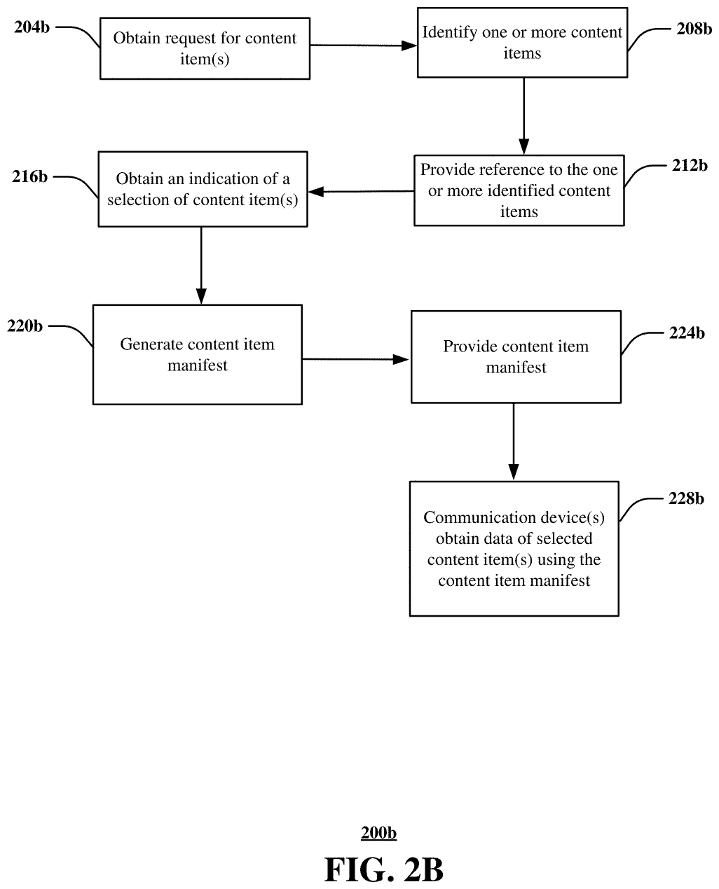

FIG. 2A is a block diagram illustrating an example, non-limiting embodiment of a system 200a functioning within, or operatively overlaid upon, the communication network 100 of FIG. 1 in accordance with various aspects described herein. The system 200a may include one or more communication devices. For example, the system 200a is shown in FIG. 2A as including a first user equipment (UE) 202a-1, a second UE 202a-2, a third UE 202a-3, an analysis server 206a, a first content server 210a-1, a second content server 210a-2, and a third content server 210a-3. Each of the content servers 210a-1 through 210a-3 may be associated with one or more storage devices. To demonstrate, the first content server 210a-1 may be associated with a first database 214a-1, the second content server 210a-2 may be associated with a second database 214a-2, and the third content server 210a-3 may be associated with a third database 214a-3.

As shown in FIG. 2A, aspects of the system 200a may conform to a client-server architecture/arrangement. In some embodiments, the system 200a may incorporate aspects of a peer-to-peer network. For example, once a client (e.g., the first UE 202a-1) obtains a portion of a content item, that client may, in turn, potentially provide that portion of the content item to another client (e.g., the second UE 202a-2). While the servers 206a, 210a-1, 210a-2, and 210a-3 are shown separately in FIG. 2A, in some embodiments two or more of the servers may be included/incorporated as part of a common structure (e.g., may be included within a common casing or housing). Similarly, a given storage device (e.g., the first database 214a-1) may be included/incorporated as part of one or more of the servers (e.g., the first content server 210a-1).

A given UE may be associated with one or more users. In some embodiments, the first UE 202a-1 may correspond to a first device of a first user (e.g., a laptop of the first user) and the second UE 202a-2 may correspond to a second device of the first user (e.g., a smartphone of the first user). In some embodiments, user log-in credentials (e.g., username and password, personal identification number, biometric scan information, etc.), information/data contained within a SIM card, etc., may be used to distinguish users of a given device.

The first UE 202a-1, the second UE 202a-2, and the third UE 202a-3 may be communicatively coupled to the server 206a. A given UE (e.g., the first UE 202a-1) may provide data or information to the server 206a that may correspond, or contribute, to a signature or profile of a user that uses the UE. For example, the data or information may include or pertain to: an identification of content items requested, recorded, and/or presented by the UE, browsing activity/history, purchase decisions (e.g., placing an identified product or service into a virtual shopping cart, completing a transaction for the product or service, etc.), demographic information (e.g., an identification of a user's age, sex, occupation, income level or other compensation, religious affiliation, etc.), social media activities, an identification of contacts of the user, an identification of communication sessions that the user has engaged in, applications executed by or available on the UE, the user's calendar or other schedule, etc., or any combination thereof. The signature or profile may be maintained by the server 206a, potentially in combination with one or more other devices (such as, for example, a database).

Regarding the use of content items, a given UE (or, analogously, a user of the given UE) may request one or more content items. The request may be facilitated by, e.g., a search query, a selection from: an electronic programming guide (EPG), an interactive programming guide (IPG), and/or a menu, etc. The analysis server 206a may receive the request and may identify one or more content items that are to be provided to the UE based on the request. For example, the analysis server 206a may obtain the one or more content items from, e.g., the first content server 210a-1 and may provide (e.g., transmit) the one or more content items to the given UE.

In some embodiments, the analysis server 206a may generate one or more recommendations or suggestions regarding a content item in respect of a given UE (or, analogously, a user of the given UE). For example, if a user of the given UE has a history of consuming comedies, the analysis server 206a may suggest/recommend other comedies for the user. In this regard, a given content item as provided by, e.g., the first content server 210a-1 may include metadata that may identify a genre of the content item. Other types of characteristics (e.g., identifications of characters, events of plot lines/sequences, run time/duration, program name/title, episode/track identifiers, identifications of sponsored content (e.g., advertisement) placement opportunities, etc.) may be included in the metadata.

As part of the exemplary embodiment shown in FIG. 2A, it may be assumed that the system 200a is utilized to provision data to the first UE 202a-1, the second UE 202a-2, and/or the third UE 202a-3, and that the data is associated with a series. For example, the series may be defined by, or organized as, one or more seasons, such as for example a first season (S1) and a second season (S2). Still further, it may be assumed that each of the seasons S1 and S2 includes fourteen episodes E, e.g., episode E1 through episode E14. In this regard, the data associated with a given episode may be denoted in FIG. 2A as SX.EY, where the ‘X’ in SX denotes the season number and the ‘Y’ in EY denotes the episode number within that season. Thus, in FIG. 2A the notation S2.E1 represents the data associated with the first episode in the second season.

It may further be assumed that each of the content servers 210a-1 through 210a-3 is a different source of content. One or more of the content servers 210a-1 through 210a-3 may be associated with a license or subscription model, such that a user's access to content items provided by a given content server (or, analogously, a database associated with the given server) may be granted based on the payment of a license/subscription fee. In this regard, the analysis server 206a and/or the given content server (e.g., the first content server 210a-1) may administer a service to facilitate a provisioning of content items to UEs (e.g., the first UE 202a-1) based on obtaining payment from the UEs (or users thereof).

Taken collectively, the content servers 210a-1 through 210a-3 (or, analogously, the databases 214a-1 through 214a-3) may host some or all of a catalog associated with the series. For example, and assuming any subscription/license fees as required have been paid, taken collectively the content servers 210a-1 through 210a-3 may enable a user to watch the series from season 1, episode 1 (S1.E1) through season 2, episode 14 (S2.E14). However, the entirety of the catalog might not be available from a single source. To demonstrate:

the first database 214a-1 may host/store data associated with: season 1, episode 1 (S1.E1) through season 1, episode 7 (S1.E7) and season 2, episode 1 (S2.E1) through season 2 episode 5 (S2.E5);

the second database 214a-2 may host/store data associated with: season 1, episode 8 (S1.E8) through season 1, episode 14 (S1.14) and season 2, episode 2 (S2.E2) through season 2, episode 4 (S2.E4); and

the third database 214a-3 may host/store data associated with: season 2, episode 4 (S2.E4) through season 2, episode 14 (S2.14).

As a further wrinkle/refinement on the foregoing, in some embodiments a given episode may, or might not, be available in one or more formats or resolutions. For example, the episodes of the first season (S1) might only be available in a low-definition (LD) format/resolution, whereas one or more of the episodes of the second season (S2) may be available in a LD format/resolution and a high-definition (HD) format/resolution. In this regard, the first database 214a-1 may host/store data associated with a LD rendering for S2.E1 through S2.E5 and may host/store data associated with a HD rendering for S2.E1 through S2.E3. Similarly, the data hosted/stored by the second database 214a-2 in respect of S2.E2 through S2.E4 may facilitate an HD presentation/rendering.

In some embodiments, the provisioning of a given episode in LD or HD may adhere/conform to an adaptive bit rate (ABR) model/technique/algorithm, such as for example in relation to an execution of a streaming video application. To demonstrate, the first episode in the second season (S2.E1) may be available from the first content server 210a-1/first database 214a-1 in both LD and HD formats/resolutions. The choice/selection of LD or HD to use to provide S2.E1 to a given UE may be determined/identified/selected, potentially in real-time, and may be based on one or more factors or considerations, such as for example network load, bandwidth, processing resource capacity, battery capacity/level at the UE, etc.

As the foregoing description demonstrates, in some instances a UE may obtain data associated with a given episode from more than one source. For example, a HD rendering/presentation of the third episode in the second season (S2.E3) may be obtained via the first content server 210a-1/first database 214a-1 or the second content server 210a-2/second database 214a-2. In this regard, aspects of the system 200a may promote reliability, whereby the data associated with, e.g., S2.E3 may be obtained from the second content server 210a-2/second database 214a-2 in the event that the first content server 210a-1/first database 214a-1 is inoperable or unavailable (e.g., is offline, is powered-down, etc.).

In some embodiments, the analysis server 206a may provide a master manifest/playlist to a given UE. To demonstrate, and continuing the above example, if the first UE 202a-1 requested the series referred to above in relation to FIG. 2A (perhaps via parameters of a search query that identify a title of the series, a character or actor/actress name that appears in the series, etc.), the master manifest provided to the first UE 202a-1 may include a listing of each episode from seasons 1 and 2. Furthermore, a description of each of the episodes may be provided as part of the master manifest, such as for example a brief description of events that happen within each episode. This brief description may enable a user to decide whether he/she wants to watch a given episode referenced in the master manifest. In some embodiments, an image associated with an episode referenced within the master manifest may be included in a presentation of the master manifest, so that the user might tend to remember/recall the (events of the) episode the next time the user sees the image. In some embodiments, a video trailer associated with an episode referenced within the master manifest may be included in a presentation of the master manifest. A user may play the video trailer to obtain a better understanding of what the episode is about prior to selecting the episode for playback.

In some embodiments, an identification of one or more potential sources of an episode (e.g., an identity of a service provider associated with the content servers/databases of FIG. 2A that potentially provide the data associated with a given episode) may be provided in the master manifest. In this regard, and all other conditions being assumed equal, a user may select a preferred source of the episode (assuming multiple potential sources of the episode are available). In other embodiments, the identification of the source(s) may be hidden from the view/perspective of the user in the master manifest. In such embodiments, and from the perspective of a user, the episodes may all appear to be originating from a service provider associated with the analysis server 206a.

In some embodiments, a master manifest that is provided to a communication device may include an identification of a format/resolution of episodes that are available. For example, in relation to S2.E1-S2.E5, those episodes may be available in both LD and HD formats/resolutions. All conditions being equal, a user may be encouraged to select (and may select) the HD format/resolution from the master manifest, as doing so may provide for a better user QoE. However, in some instances the user may opt for the LD format/resolution, such as for example if the user's communication device (e.g., UE) is running low on battery power, and the user would prefer to tradeoff quality in presentation for extended battery life.

In some embodiments, a listing of episodes that is provided in a master manifest may be based on capabilities of a communication device that obtains the master manifest. For example, if the second UE 202a-2 provided the analysis server 206a with a search query related to the title of the series referred to above, but the second UE 202a-2 lacks resources (e.g., display resources, audio resources, etc.) to facilitate/leverage an HD presentation, the master manifest provided by the analysis server 206a to the second UE 202a-2 may include a reference to S1.E1-S1.E14 and S2.E1-S2.E5. Stated differently, and due to the (lack of) resources available at the second UE 202a-2, the master manifest provided by the analysis server 206a to the second UE 202a-2 may omit S2.E6-S2.E14, since those episodes are only available in HD format/resolution in the example embodiment represented by FIG. 2A.

In some embodiments, a listing of episodes that is provided by a master manifest may be based on preferences of a user of a communication device that obtains the master manifest. The preferences may be included as part of one or more profiles. For example, if a user of the third UE 202a-3 only desires to watch episodes in an HD format/resolution, the master manifest provided by the analysis server 206a to the third UE 202a-3 may include a reference to S2.E1-S2.E14. Stated differently, the episodes associated with the first season (S1) may be omitted from the master manifest provided to the third UE 202a-3 since only LD versions of those episodes are available in the example embodiment represented by FIG. 2A.

In some embodiments, data associated with a given episode may be prefetched by the analysis server 206a from one or more sources (e.g., from the first content server 210a-1, the second content server 210a-2, and/or the third content server 210a-3) in advance of receiving an indication from a UE of a request for/selection of the given episode referenced in a master manifest. Doing so may help to reduce a startup time delay/lag from a selection of an episode until a sufficient amount of data (e.g., data in an amount greater than a threshold) has been transferred/provided to the UE to starting rendering the episode at the UE. To further reduce the startup time delay/lag, in some embodiments (a portion of) the data may be transferred/transmitted by the analysis server 206a to the UE in advance of a request for/selection of the given episode.

In some embodiments, a copy of data associated with an episode (or one or more portions thereof) may be stored at/by the analysis server 206a to facilitate provisioning that same data (or a variant thereof) in the future. For example, data associated with a threshold count of the most popular episodes may be stored in a cache, or other storage device, of the analysis server 206a to avoid the analysis server 206a having to reobtain the same data multiple times within a given time period.

Once a selection of an episode is made from a master manifest, the UE associated with the selection may provide (e.g., transmit) an indication of the selection to the analysis server 206a. In response to obtaining (e.g., receiving) the indication of the selection, the analysis server 206a may provide the UE with a content item manifest/playlist. The content item manifest may provide a listing of sources that the UE may acquire one or more portions of the episode from. To demonstrate, if the first UE 202a-1 requested the second episode in the second season (S2.E2), the analysis server 206a may provide to the first UE 202a-1 a content item manifest that refers to the first content server 210a-1 and the second content server 210a-2 as alternatives, since S2.E2 may be obtained from either the first database 214a-1 or the second database 214a-2. The listing of sources in a content item manifest may take the form of one or more addresses, links, uniform resource locators (URLs), or the like, associated with content servers, databases, other UEs, etc.

Referring now to FIG. 2B, an illustrative embodiment of a method 200b in accordance with various aspects described herein is shown. The method 200b may be executed, in whole or in part, by one or more systems, devices, and/or components, such as for example the systems, devices, and components set forth herein. The method 200b may be executed to facilitate a playback or presentation of one or more content items, such as one or more videos, by/at one or more communication devices (e.g., one or more UEs).

In block 204b, a request for one or more content items may be obtained. The request of block 204b may be an affirmative request, such as for example a selection of a particular content item from an EPG, IPG, or menu as described above, a search query, etc. In some embodiments, the request of block 204b may be passive in nature, such as for example a user powering-on/turning on a power supply of a first communication device (e.g., a UE), and pushing suggestions or recommendations regarding one or more content items to the first communication device. The request of block 204b may originate from a communication device (e.g., the first communication device) that will record/save/store the content item and/or playback/present the content item, or from another communication device that acts (as a proxy) on behalf of the first communication device.

In block 208b, one or more content items may be identified, potentially in response to the obtaining of the request as part of block 204b. For example, block 208b may include identifying access rights of the first communication device to content items hosted/stored by one or more content service providers (or associated servers, databases, etc.), and selecting one or more of the content items based on granted access rights. Block 208b may include identifying one or more capabilities of the first communication device and selecting one or more content items based on the one or more capabilities. Block 208b may include identifying one or more preferences (e.g., user preferences) associated with the first communication device (or a user thereof) and selecting one or more content items based on the one or more preferences.

In block 212b, references to the one or more content items identified as part of block 208b may be provided to the first communication device (or the another communication device described above in relation to block 204b). The references to the one or more content items of block 212b may be included as part of a master manifest as described above. In some embodiments, the references to the one or more content items may include a description of the content items, one or more images or videos (e.g., preview trailers) associated with the content items, commentary (e.g., social media commentary) regarding the content items, identifications of plotlines or sequences associated with the content items, identifications of characters associated with the content items, identifications of qualities/characteristics (e.g., a formatting or a resolution, a runtime or duration, etc.) associated with the content items, identifications of sources of the content items, etc., or any combination thereof.

In block 216b, an indication of a selection of one or more content items may be obtained. For example, the indication of the selection may be obtained from the first communication device responsive to a user selection of the one or more content items from the master manifest described above.

In block 220b, a content item manifest may be generated based on the indication of the selection obtained as part of block 216b. For example, the content item manifest may include an identification of one or more locations where one or more portions of the content item(s) selected as part of block 216b may be obtained.

In block 224b, the content item manifest of block 220b may be provided to the first communication device (or the another communication device described above in relation to block 204b). The first communication device (or the another communication device, as applicable) may parse, or otherwise process, the content item manifest and may obtain/retrieve data associated with the selected content item(s) from the location(s) identified in the content item manifest.

In block 228b, the first communication device (or, where applicable, the another communication device described above in relation to block 204b) may save/store/record the data obtained as part of block 224b to facilitate a future presentation/playback of the selected content item(s) and/or may process the data to present/playback/render the selected content item(s).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described above, aspects of this disclosure may facilitate a playback or rendering of one or more content items. In some of the examples set forth above, the content items included one or more videos. Aspects of this disclosure may be applied in respect of other types of content items, including other types of media. For example, in some embodiments a content item may include: an image, audio (e.g., musical tracks), text or other document, a message (e.g., a text message, an email, a social media message, etc.), etc.

In some embodiments, content items available from disparate sources may be akin to an availability of content items from multiple channels in a traditional television distribution platform. Even in relation to a single source, different versions of a content item (e.g., different formats or resolutions of the content item) of this disclosure may effectively be analogized to different channels. Aspects of the disclosure may treat the different sources (or versions) of content items as continuous streams, with discontinuities present between the sources/versions. A switching between the streams may be intelligently facilitated to reduce the time it takes to present the different content items.

Aspects of this disclosure may be facilitated by one or more systems, devices, and/or components. One or more methodological acts or processes may be facilitated by one or more applications (e.g., client applications), players (e.g., video players, audio players, etc.), proxies/proxy devices, etc. For example, and as described herein, a communication device may serve as a proxy representative of multiple sources/outlets of content.

Aspects of this disclosure may aggregate (references to) content items within/under a common framework/umbrella, thereby alleviating a user of a need to parse information pertaining to potentially different/disparate sources of the content items. For example, and from the perspective of the user, the content items may appear to originate from a single source or location, such as for example a service provider.

Aspects of this disclosure may facilitate so-called “binge watching”, whereby a user consumes content/content items over a first time duration that is less than a second time duration associated with a scheduled, initial distribution of the content/content items. For example, and referring to the episodes of FIG. 2A described above, in some instances a new episode within a series may initially be available from a content creator or content distributor on, e.g., a weekly basis. However, in accordance with aspects of time-shifted viewing, a user may desire to consume the episodes at a faster rate; e.g., the user may consume all of the episodes associated with the first season (e.g., S1.E1-S1.E14) in a single day. To the extent that the episodes of the first season are available for such time-shifted viewing from multiple sources, a user may have an option to select one or more of those episodes for playback and the systems/platforms of this disclosure may handle the details of obtaining the data associated with the episodes from the multiple sources. In this regard, a user may be presented with a “binge watch” option that, when selected, enables retrieval and presentation of multiple episodes back-to-back. Data from disparate sources or outlets may be obtained via a content item manifest that references such sources or outlets.

In some embodiments, breaks may be inserted between episodes of a binge watching session to enable the user to, e.g., stretch his/her legs, use the restroom, obtain a food item (e.g., a snack) or beverage, etc. The breaks between the episodes may facilitate a presentation of one or more advertisements. Even within a presentation of a given episode, one or more breaks may be included to facilitate a presentation of one or more advertisements. In this regard, aspects of the disclosure may facilitate a distribution of sponsored content items, such as for example the episodes referred to above. As one skilled in the art would appreciate, the costs associated with creating and distributing content items may be defrayed/reduced via the inclusion of advertisements directed to one or more products or services. The advertisements may populate inventory (e.g., the breaks referred to above) that is available within the content items. The advertisements that are presented may be identified/selected/determined in accordance with a user profile that may be accessed by one or more devices. In some embodiments, locations on a network where the advertisements may be obtained may be included in one or more manifests, such as for example a master manifest and/or a content item manifest.

In some embodiments, one or more commands or directives may be issued/provided to a communication device. The commands, which may be included as part of a manifest, a message, or the like, may cause the communication device to take one or more actions, including for example obtaining/retrieving data from one or more locations or sources, processing the data, presenting/rendering content items associated with the processed data, etc.

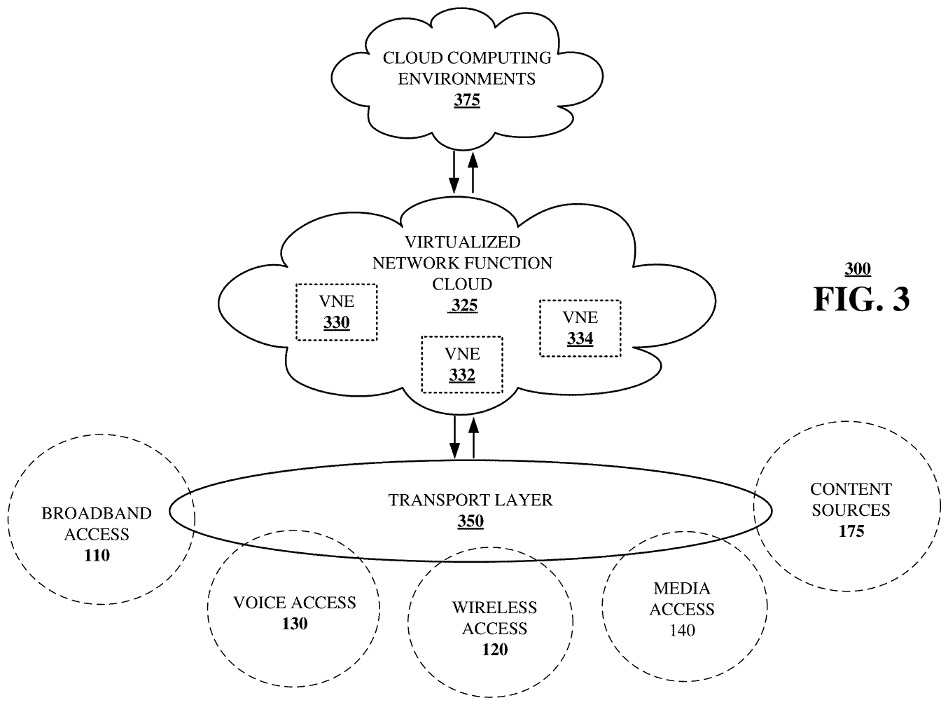

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, virtualized communication network 300 can facilitate in whole or in part obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored. Virtualized communication network 300 can facilitate in whole or in part obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. Virtualized communication network 300 can facilitate in whole or in part determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

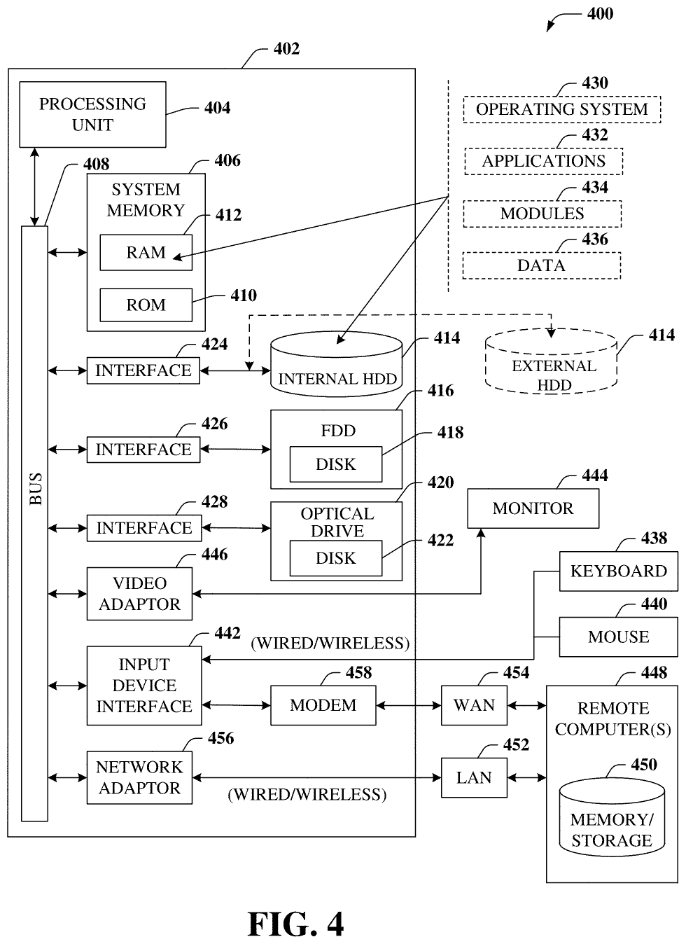

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored. Computing environment 400 can facilitate in whole or in part obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. Computing environment 400 can facilitate in whole or in part determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

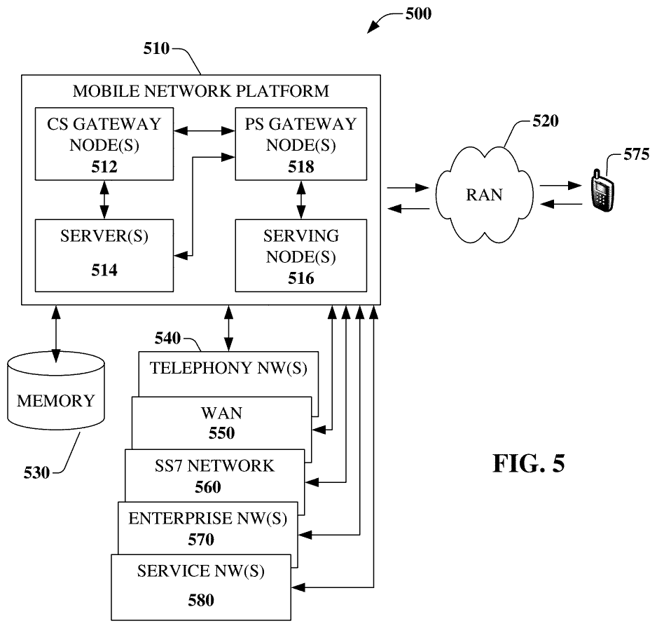

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored. Platform 510 can facilitate in whole or in part obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. Platform 510 can facilitate in whole or in part determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

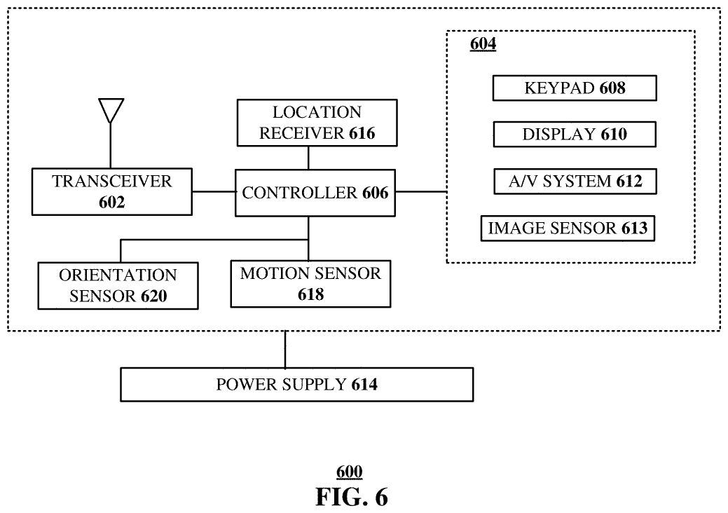

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part obtaining a request from a user equipment, identifying a first plurality of sources of a first plurality of content items responsive to the obtaining of the request, identifying a second plurality of sources included in the first plurality of sources based on a first identity of the user equipment, a second identity of a user of the user equipment, or a combination thereof, providing a first manifest to the user equipment, wherein the first manifest includes references to content items hosted by the second plurality of sources, obtaining, from the user equipment and based on the providing of the first manifest to the user equipment, an indication of a selection of at least one content item included in the content items hosted by the second plurality of sources, and providing a second manifest to the user equipment responsive to the obtaining of the indication of the selection of the at least one content item, wherein the second manifest identifies a location on a network where first data associated with the at least one content item is stored. Computing device 600 can facilitate in whole or in part obtaining a first manifest that identifies a plurality of videos, wherein a first video included in the plurality of videos is hosted by at least a first server and a second video included in the plurality of videos is hosted by a second server that is different from the first server, transmitting a first indication of a first selection of the first video, subsequent to the transmitting of the first indication of the first selection of the first video, obtaining a second manifest that identifies at least a first location of the first server on a network, and obtaining first data associated with the first video from a location identified by the second manifest. Computing device 600 can facilitate in whole or in part determining that a communication device is authorized to access a first content item hosted by a first service provider and a second content item hosted by a second service provider, transmitting, to the communication device, a first identification of the first content item and a second identification of the second content item, receiving a selection of the first content item and the second content item from the communication device, and responsive to the receiving of the selection, providing, to the communication device, a first indication of a first address associated with the first service provider and a second indication of a second address associated with the second service provider.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
obtaining a request from a user equipment;
identifying a first plurality of sources of a first plurality of content items responsive to the obtaining of the request;
identifying a second plurality of sources included in the first plurality of sources based on a first identity of the user equipment, a second identity of a user of the user equipment, or a combination thereof;
providing a first manifest to the user equipment, wherein the first manifest includes references to content items hosted by the second plurality of sources, wherein the references of the first manifest include a first reference to a first version of a content item hosted by at least one source included in the second plurality of sources and a second reference to a second version of the content item hosted by the at least one source included in the second plurality of sources, wherein the first version of the content item is associated with a first resolution, wherein the second version of the content item is associated with a second resolution, and wherein the first resolution is different from the second resolution;
obtaining, from the user equipment and based on the providing of the first manifest to the user equipment, an indication of a selection of at least one content item included in the content items hosted by the second plurality of sources; and
providing a second manifest to the user equipment responsive to the obtaining of the indication of the selection of the at least one content item, wherein the second manifest identifies a location on a network where first data associated with the at least one content item is stored.

2. The device of claim 1, wherein the request includes a search query, and wherein the identifying of the first plurality of sources is based on a parameter included in the search query.

3. The device of claim 2, wherein the at least one content item includes a video, and wherein the parameter includes: an identification of an actor or an actress in the video, an identification of a character name in the video, an identification of an event that occurs in a plot of the video, a name or title associated with the video, or any combination thereof.

4. The device of claim 1, wherein the identifying of the second plurality of sources included in the first plurality of sources based on the first identity of the user equipment, the second identity of a user of the user equipment, or the combination thereof, comprises identifying that the user equipment, the user, or a combination thereof, is authorized to access content items of the second plurality of sources.

5. The device of claim 1, wherein the operations further comprise:
identifying a capability of the user equipment,
wherein the identifying of the second plurality of sources is further based on the identifying of the capability of the user equipment.

6. The device of claim 1, wherein the operations further comprise:
identifying a preference of the user,
wherein the identifying of the second plurality of sources is further based on the preference.

7. (canceled)

8. The device of claim 1, wherein the first version of the content item is hosted by a first source included in the second plurality of sources and the second version of the content item is hosted by a second source included in the second plurality of sources that is different from the first source.

9. The device of claim 1, wherein the first version of the content item is hosted by a same source as the second version of the content item.

10. The device of claim 1, wherein the first version of the content item is associated with a first format, wherein the second version of the content item is associated with a second format, and wherein the first format is different from the second format.

11. The device of claim 1, wherein the indication of the selection of at least one content item included in the content items hosted by the second plurality of sources includes a selection of a first content item hosted by the second plurality of sources, and wherein the operations further comprise:
obtaining second data associated with a second content item hosted by the second plurality of sources.

12. The device of claim 11, wherein the operations further comprise:
subsequent to the obtaining of the second data, obtaining a second indication of a second selection of the second content item from the user equipment; and
providing at least a portion of the second data to the user equipment responsive to the obtaining of the second indication of the second selection.

13. The device of claim 11, wherein the operations further comprise:
providing a portion of the second data to the user equipment;
subsequent to the providing of the portion of the second data to the user equipment, obtaining a second indication of a second selection of the second content item from the user equipment; and
commanding the user equipment to present a portion of the second content item in accordance with the portion of the second data.

14. A non-transitory machine-readable medium, comprising executable instructions that, when executed by a processing system including a processor, facilitate performance of operations, the operations comprising:
obtaining a first manifest that identifies a plurality of videos, wherein a first version of a first video included in the plurality of videos is hosted by at least a first server with a first resolution, a second video included in the plurality of videos is hosted by a second server that is different from the first server, and a second version of the first video is hosted by a third server with a second resolution that is different from the first resolution;
transmitting a first indication of a first selection of the first video;
subsequent to the transmitting of the first indication of the first selection of the first video, obtaining a second manifest that identifies at least a first location of the first server, a second location of the third server, or a combination thereof, on a network; and
obtaining first data associated with the first video from a location identified by the second manifest.

15. (canceled)

16. The non-transitory machine-readable medium of claim 14, wherein the obtaining of the first manifest is based on a power supply of the processing system being turned on.

17. The non-transitory machine-readable medium of claim 14, wherein the operations further comprise:
subsequent to the obtaining of the first data, processing the first data to facilitate a rendering of first images of the first video on a display device of the processing system;
subsequent to the processing of the first data, transmitting a second indication of a second selection of the second video;
subsequent to the transmitting of the second indication of the second selection of the second video, obtaining a third manifest that identifies a third location on the network of the second server;
obtaining second data associated with the second video from the third location on the network of the second server; and
processing the second data to facilitate a rendering of second images of the second video on the display device.

18. A method, comprising:
determining, by a processing system including a processor, that a communication device is authorized to access a first content item hosted by a first service provider and a second content item hosted by a second service provider;
transmitting, by the processing system and to the communication device, a first identification of the first content item and a second identification of the second content item, wherein the first identification of the first content item includes an indication that the first content item is available in at least two resolutions that differ from one another;
receiving, by the processing system, a selection of the first content item and the second content item from the communication device; and
responsive to the receiving of the selection, providing, by the processing system and to the communication device, a first indication of at least a first address associated with the first service provider and a second indication of a second address associated with the second service provider to cause the communication device to present the first content item and the second content item.

19. The method of claim 18, wherein the first content item comprises a video, and wherein the second content item comprises: an image, text, a document, a musical track, a message, or any combination thereof.

20. The method of claim 18, further comprising:
identifying a user of the communication device;
accessing a user profile based on the identifying of the user;
identifying a first advertisement based on the accessing of the user profile;
identifying a second advertisement based on the accessing of the user profile;
providing, by the processing system and to the communication device, a third indication of a third address associated with the first advertisement to cause the communication device to present the first advertisement between a first presentation of a first portion of the first content item and a second presentation of a second portion of the first content item; and
providing, by the processing system and to the communication device, a fourth indication of a fourth address associated with the second advertisement to cause the communication device to present the second advertisement between the second presentation and a third presentation of the second content item.

21. The method of claim 18, wherein the transmitting of the first identification of the first content item and the second identification of the second content item is based on a user profile associated with a user of the communication device, wherein the user profile includes: an identification of content items requested by the communication device, content items recorded by the communication device, content items presented by the communication device, browsing activity, purchase decisions, demographic information, social media activities, contacts of the user, an identification of communication sessions that the user has engaged in, applications executed by or available on the communication device, and a calendar of the user.

22. The method of claim 18, further comprising:
identifying, by the processing system, a network load, an available bandwidth, a processing resource capacity, and a battery level of the communication device; and
selecting, by the processing system, a first resolution of the at least two resolutions based on the identifying, wherein the at least a first address includes the first address and a third address, and wherein the first address is associated with the first resolution and the third address is associated with a second resolution of the at least two resolutions.
